(19) United States
(12) Patent Application Publication
(10) Pub. No.: US 2025/0067949 A1
(43) Pub. Date: Feb. 27, 2025

(54) CABLE MANAGEMENT DEVICE

(71) Applicant: Hubbell Incorporated, Shelton, CT (US)

(72) Inventors: Adam Joseph Clark, Greenville, SC (US); Adrian Beau Candelaria, Montevallo, AL (US)

(73) Assignee: Hubbell Incorporated, Shelton, CT (US)

(21) Appl. No.: 18/810,918

(22) Filed: Aug. 21, 2024

Related U.S. Application Data
(60) Provisional application No. 63/578,047, filed on Aug. 22, 2023.

(51) Int. Cl. G02B 6/44; H02G 11/02

(52) U.S. Cl. CPC G02B 6/4457; G02B 6/44785; H02G 11/02

(57) ABSTRACT

A cable management device includes an enclosure including a first retaining feature, and a cable spool mounted to the enclosure and including a second retaining feature. The Second retaining feature is movable between a closed position and an open position. A method for storing cable in a cable management device includes moving the second retaining feature from the closed position to the open position to increase a distance between the first and second retaining features to open a corresponding space between the first and second retaining features, spooling a cable around the cable spool, and moving the second retaining feature from the open position to the closed position to decrease the distance between the first and second retaining features to reduce or close the corresponding space between the first and second retaining features.

### CROSS-REFERENCE TO RELATED APPLICATION

This application claims the benefit of U.S. Provisional Application No. 63/578,047, filed Aug. 22, 2023, the entire contents of which are incorporated herein by reference in its entirety.

### FIELD

The present disclosure relates to cable management devices, such as network interface devices (NIDs).

### BACKGROUND

Network interface devices (NIDs) serve as important components of a network infrastructure, responsible for connecting customer premises equipment to the network provider's equipment. NIDs are typically installed on the exterior of a residence or apartment building (e.g., serving multiple households), although NIDs can be installed in any type of structure. Cable management is an integral aspect of NID installation and maintenance, as poor cable management can lead to a variety of problems, such as cable tangling, cable strain, and inefficient use of space.

For example, poorly managed cables can become tangled, making it difficult to access individual cables for troubleshooting or maintenance purposes. This can result in delays and increased service downtime. Furthermore, cables that are not properly managed can be subjected to excessive strain, leading to damage or even failure. This can result in service disruptions and increased repair costs. Minimum bend radii are generally required with certain types of cabling, such as fiber optic cabling, thus further necessitating orderly cable management.

Poor cable management can also lead to inefficient use of space, as cables may take up more volume than necessary, leading to limitations on future equipment installation or upgrades.

NIDs are also configured to accommodate various cable sizes (e.g., different diameters, widths, shapes, etc.), and may include connector pigtails and splice arrays for connection to the utility side cabling.

### SUMMARY

Various examples of the present disclosure can overcome various of the aforementioned and other disadvantages associated with known cable management devices and offer new advantages as well.

According to one aspect of various examples of the present disclosure there is provided a cable management device including an enclosure including a first retaining feature, and a cable spool mounted to the enclosure, and including a second retaining feature. The second retaining feature is movable between a closed position and an open position, such that moving the second retaining feature from the closed position to the open position increases a distance between the first and second retaining features to open a corresponding space between the first and second retaining features.

According to another aspect of various examples of the present disclosure, the cable spool is fixedly mounted to the enclosure and the second retaining feature is a cantilever portion that can flex between the closed rotational position and the open rotational position.

According to another aspect of various examples of the present disclosure, the cable spool is rotatably mounted to the enclosure and the cable spool is rotatable between a closed rotational position and an open rotational position.

According to one aspect of various examples of the present disclosure there is provided a cable management device including an enclosure including a first retaining feature, and a cable spool fixedly mounted to the enclosure, and including a second retaining feature. The second retaining feature is flexible relative to the first retaining feature between a closed position and an open position, such that moving the second retaining feature from the closed position to the open position increases a distance between the first and second retaining features to open a corresponding space between the first and second retaining features.

According to one aspect of various examples of the present disclosure there is provided a cable management device including an enclosure including a first retaining feature, and a cable spool rotatably mounted to the enclosure, and including a second retaining feature. The cable spool is rotatable between a closed rotational position and an open rotational position, such that rotating the cable spool from the closed rotational position to the open rotational position increases a distance between the first and second retaining features to open a corresponding space between the first and second retaining features.

According to another aspect of various examples of the present disclosure, the cable management device includes a plurality of corresponding first and second retaining features respectively defining a corresponding one of a plurality of spaces, the plurality of first retaining features being disposed circumferentially around the cable spool.

According to another aspect of various examples of the present disclosure, the cable spool is rotatably mounted to the enclosure by at least one fastener disposed through a slotted hole of the enclosure or of the cable spool. The at least one slotted hole defines an angular difference between the closed and open rotational positions of the cable spool.

According to another aspect of various examples of the present disclosure, the closed and open rotational positions of the cable spool are offset by an angle selected within a range of 10-20 degrees.

According to another aspect of various examples of the present disclosure, the cable spool is lockable in the closed rotational position by a detent.

According to another aspect of various examples of the present disclosure, the cable management device includes a secondary cable slack storage area defined by retaining tabs in an interior portion of the cable spool.

According to another aspect of various examples of the present disclosure, the enclosure includes a cable entry opening fitted with a segmented grommet. The segmented grommet includes a plurality of telescoping tubular segments having different sizes (e.g., diameters, widths, shapes, etc.).

According to another aspect of various examples of the present disclosure, the segmented grommet is configured to fit into the cable entry opening in two opposite orientations.

According to another aspect of various examples of the present disclosure, there is provided a method for storing cable in a cable management device. The cable management device includes an enclosure including a first retaining feature, and a cable spool mounted to the enclosure and including a second retaining feature, the second retaining feature being movable between a closed position and an open position. The method includes moving the second retaining feature from the closed position to the open position to increase a distance between the first and second retaining features to open a corresponding space between the first and second retaining features, spooling a cable around the cable spool, and moving the second retaining feature from the open position to the closed position to decrease the distance between the first and second retaining features to reduce or close the corresponding space between the first and second retaining features.

According to another aspect of various examples of the present disclosure, the cable spool is fixedly mounted to the enclosure and the second retaining feature is a cantilever portion that can flex between the closed position and the open position.

According to another aspect of various examples of the present disclosure, there is provided a cable management device that includes an enclosure with a base and a door. The door moves relative to the base. The door includes a gasket with a solid cross section.

According to another aspect of various examples of the present disclosure, there is provided a splice chip supported within an enclosure. The splice chip can allow for connection between cables within the enclosure.

In some forms, the enclosure may include a flexible film disposed to at least partially cover the splice chip.

In some forms, the splice chip can accommodate up to 24 splices.

According to another aspect of various examples of the present disclosure, there is provided a cable management device that includes an enclosure. The enclosure includes a mounting region having an outer perimeter. A splice chip disposed within the outer perimeter.

In some forms, a raised surface is disposed within the outer perimeter. The splice chip is mounted to the raised surface.

In some forms, the mounting region is substantially flat across its area.

According to another aspect of various examples of the present disclosure, there is provided a method for storing cable in a cable management device. The cable management device includes an enclosure including a first retaining feature, and a cable spool fixedly mounted to the enclosure and including a second retaining feature, the second retaining feature being movable between a closed position and an open position. The method includes moving the second retaining feature relative to the first retaining feature from the closed position to the open position to increase a distance between the first and second retaining features to open a corresponding space between the first and second retaining features, spooling a cable around the cable spool, and moving the second retaining feature from the open position to the closed position to decrease the distance between the first and second retaining features to reduce or close the corresponding space between the first and second retaining features.

According to another aspect of various examples of the present disclosure, there is provided a method for storing cable in a cable management device. The cable management device includes an enclosure including a first retaining feature, and a cable spool rotatably mounted to the enclosure and including a second retaining feature, the cable spool being rotatable between a closed rotational position and an open rotational position. The method includes rotating the cable spool from the closed rotational position to the open rotational position to increase a distance between the first and second retaining features to open a corresponding space between the first and second retaining features, spooling a cable around the cable spool, and rotating the cable spool from the open rotational position to the closed rotational position to decrease the distance between the first and second retaining features to reduce or close the corresponding space between the first and second retaining features.

According to another aspect of various examples of the present disclosure, in a method for storing cable in a cable management device, the cable management device includes a plurality of corresponding first and second retaining features respectively defining a corresponding one of a plurality of spaces, the plurality of first retaining features being disposed circumferentially around the cable spool.

According to another aspect of various examples of the present disclosure, in a method for storing cable in a cable management device, the cable spool is rotatably mounted to the enclosure by at least one fastener extending through a slotted hole of the enclosure or of the cable spool. The at least one slotted hole defines an angular difference between the closed and open rotational positions of the cable spool.

According to another aspect of various examples of the present disclosure, in a method for storing cable in a cable management device, the rotating of the cable spool from the closed rotational position to the open rotational position includes rotating the cable spool by an angle selected within a range of 10-20 degrees.

According to another aspect of various examples of the present disclosure, a method for storing cable in a cable management device includes unlocking the cable spool from the closed rotational position by using a detent, before the rotating of the cable spool from the closed rotational position to the open rotational position.

According to another aspect of various examples of the present disclosure, in a method for storing cable in a cable management device, the enclosure includes a cable entry opening, and the method further includes fitting the cable entry opening with a segmented grommet. The segmented grommet includes a plurality of telescoping tubular segments having different sizes (e.g., diameters, widths, shapes, etc.).

According to another aspect of various examples of the present disclosure, a method for storing cable in a cable management device includes cutting the segmented grommet at a tubular segment corresponding to a size (e.g., diameter, width, shape, etc.) of the cable.

According to another aspect of various examples of the present disclosure, a method for storing cable in a cable management device includes passing the cable through the segmented grommet prior to the fitting of the cable entry opening with the segmented grommet.

The disclosure herein should become evident to a person of ordinary skill in the art given the following enabling description and drawings. The drawings are for illustration purposes only and are not drawn to scale unless otherwise indicated. The drawings are not intended to limit the scope of the disclosure. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred examples and reference to the accompanying drawing wherein:

FIG. 1A shows a perspective view of a cable management device according to an exemplary example of the disclosure.

FIG. 1B shows another perspective view of the cable management device of FIG. 1A, with the door omitted, according to an exemplary example of the disclosure.

FIG. 1C shows another perspective view of a cable management device of FIG. 1A, with a spooled cable, according to an exemplary example of the disclosure.

FIG. 1D shows a detail view of the cable management device of FIG. 1A, illustrating a detent for limiting rotational movement of a cable spool.

FIG. 2 shows a top view of the cable management device of FIG. 1A with a cable spool in a closed rotational position, according to an exemplary example of the disclosure.

FIG. 3 shows a top view of the cable management device of FIG. 1A with a cable spool in an open rotational position, according to an exemplary example of the disclosure.

FIGS. 4A-4F shows multiple schematic views of a segmented grommet according to an exemplary example of the disclosure, wherein (a) shows a top view, (b) shows a rear view, (c) shows a front view, (d) shows a perspective view, (e) shows a side view, and (f) shows a sectional side view taken along line A-A in (a).

FIG. 5 shows a perspective view of a cable management device, with the door omitted, according to another example of the disclosure.

FIG. 6 shows a top view of the cable management device of FIG. 5.

FIG. 7 shows a cross-sectional view of the cable management device of FIG. 5 along line 7-7, illustrating the second retaining features in a first position.

FIG. 8 shows a cross-sectional view of the cable management device of FIG. 5 along line 7-7, illustrating the second retaining features in a second position.

FIG. 9 shows a perspective view of a cable clamp used with the cable management device of FIG. 5.

FIG. 10 shows a side view of the cable clamp of FIG. 9.

FIG. 11 shows a perspective view of the cable clamp of FIG. 9 engaging a cable.

FIG. 12 shows a perspective view of a cable clamp.

FIG. 13 shows a perspective view of a cable management device, according to another example of the disclosure.

FIG. 13-1 shows a perspective view of the cable management device of claim 13 with a different cover.

FIG. 14 shows a perspective view of the cable management device of FIG. 13 with a cover removed.

FIG. 15 shows a perspective view of the cable management device of FIG. 14 with a door removed.

FIG. 16 shows a top view of the cable management device of FIG. 13 with the door removed.

FIG. 16-1 shows a top view of the cable management device of FIG. 13 with the door removed and illustrating an alternate example of the base.

FIG. 17 shows a top view of the cable management device of FIG. 14 with the door removed.

FIG. 18 shows a cross-sectional view of the cable management device of FIG. 15, viewed along line 18-18.

FIG. 19 shows a cross-sectional view of the cable management device of FIG. 15, viewed along line 19-19.

FIG. 20 shows a cross-sectional view of a door of the cable management device of FIG. 13, viewed along line 13-13.

FIG. 21 shows a cross-sectional view of the cable management device of FIG. 17, viewed along line 21-21.

FIG. 22 shows a perspective view of an alternate splice chip for use with the cable management device of FIG. 13.

### DETAILED DESCRIPTION

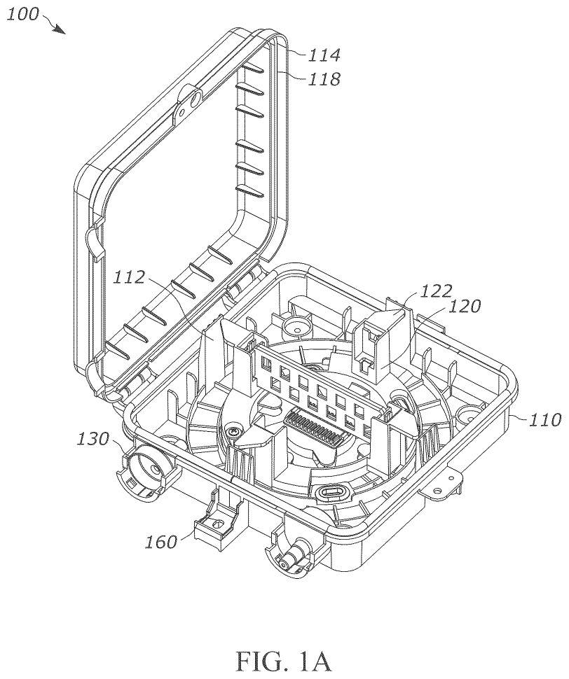

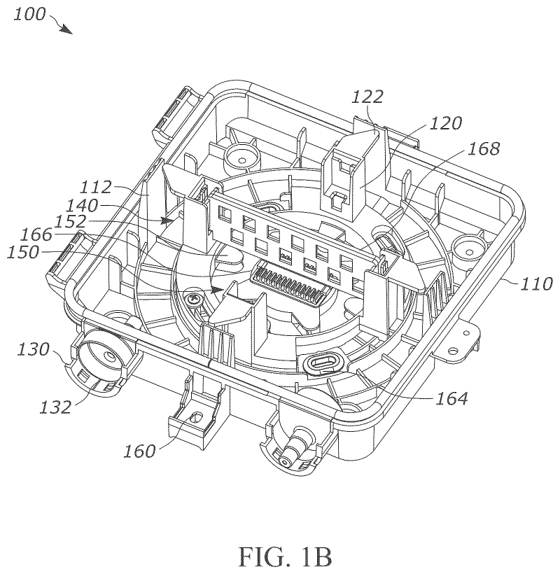

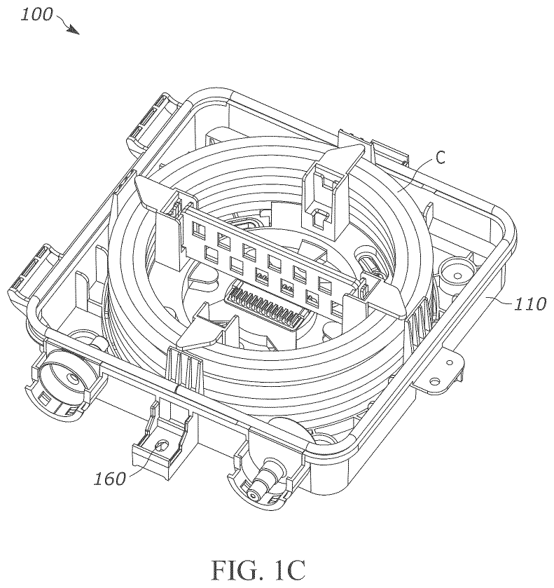

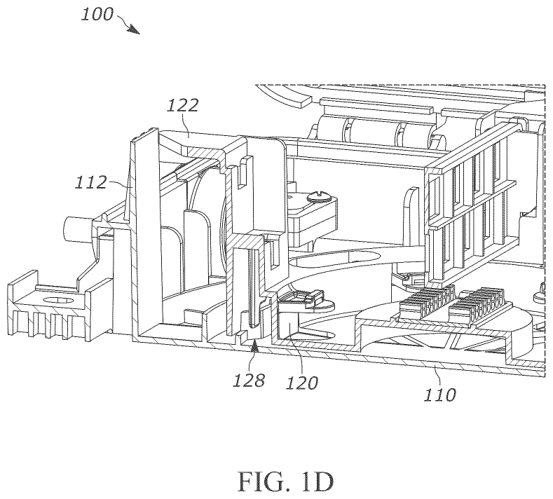

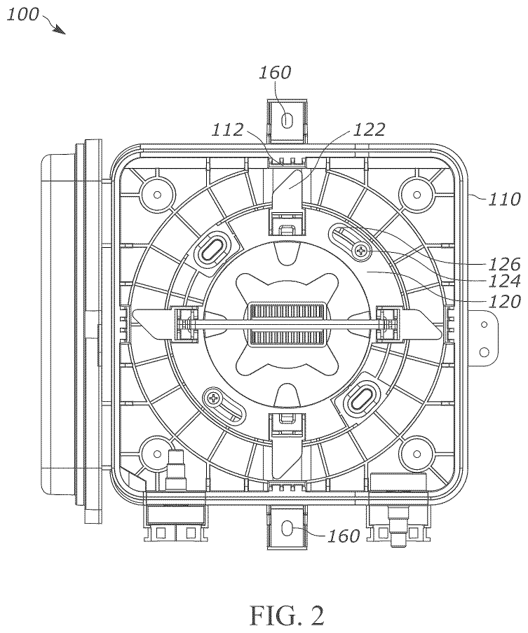

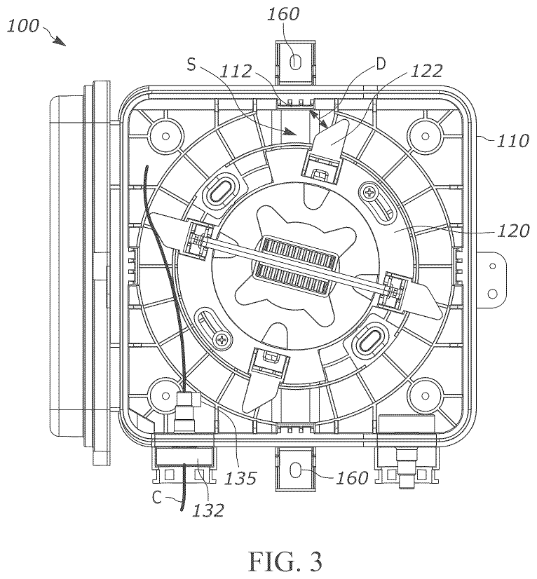

FIGS. 1A-C shows a cable management device 100 comprising an enclosure 110 and a cable spool 120 rotatably mounted to the enclosure 110. The enclosure 110 includes a first retaining feature 112, and the cable spool 120 includes a second retaining feature 122. The cable spool 120 is rotatable between a closed rotational position (FIG. 2) and an open rotational position (FIG. 3).

In illustrative examples, the enclosure 110 is closable by a door 114, and can be locked closed using a closure screw or any other suitable closing mechanism. The door 114 may be pivotable relative to the enclosure 110, although the door 114 may also be movable in other ways (e.g., via translating). A gasket 118 can provide sealing of the enclosure 110 (e.g., against moisture) around the door opening when the enclosure 110 is closed.

As illustrated in FIGS. 2 and 3, the cable management device 100 is configured such that rotating the cable spool 120 from the closed rotational position to the open rotational position increases a distance D between the first and second retaining features 112, 122 to open a corresponding space S between the first and second retaining features. In other words, the second retaining features 122 are moved relative to the first retaining features 112 (e.g., via pivoting) to increase the distance D and create the space S. The space S can allow a user to insert a cable C for spooling around the cable spool 120 during installation, or to remove the cable C from the cable spool 120. Once the cable C has been spooled, the cable spool 120 can be rotated back to the closed rotational position to prevent the cable C from coming off the cable spool 120 (i.e., so that the cable C is retained by the first and second retaining features 112, 122). In some forms, the cable spool 120 may be biased toward the closed rotational position and may automatically rotate from the open rotational position to the closed rotational position when a user releases a force on the cable spool 120 when installation is complete.

This configuration can provide a streamlined cable management process, whereby the user simply rotates the cable spool 120 before and after spooling the cable C, without having to separately spread open a clip, or other fastener, with every pass of cable. As a result, cable management during installation and/or maintenance can be streamlined and rendered more efficient. This can lead to reduced installation and repair labor and costs. This streamlined process can also be easier to implement than known methods, and thus can promote better cable management and thus reduce tangled, strained or kinked cables, and can promote more efficient use of space.

In illustrative examples, the retaining features 112, 122 can include surfaces of respective arms, or any other suitable structural aspects of the cable management device 100 having surfaces arranged to trap the cable C around the cable spool 120 when in the closed rotational position.

In illustrative examples, the cable spool 120 is rotatably mounted to the enclosure 110 by a fastener 124 (e.g., a screw with or without a washer) which extends through a slotted hole 126 of the enclosure 110 or of the cable spool 120. The slotted hole 126 can define the angular difference between the closed and open rotational positions of the cable spool 120, for example, by limiting the range of rotation of the cable spool 120 relative to the enclosure 110.

In other examples, one or more stops (e.g., mechanical stops—not shown) may be positioned proximate to the ends of the slotted hole 126. The cable spool 120 may be able to rotate the angular distance between the mechanical stops, which may define the closed and opened rotational positions. In this example, the slotted hole 126 may have a larger angular distance than the range of movement between the opened and closed rotational positions.

In other examples, a slotted hole 126 may be replaced with a center hole and a single fastener 124. This example may provide more rotational freedom (e.g., because rotation may not be limited by the length of a slot).

In illustrative examples, the closed and open rotational positions of the cable spool 120 can be offset by 15 degrees, or any angle selected within a range of 10-20 degrees, or any angle selected within a range of 10-90 degrees, though smaller or larger angular differences can be implemented depending on the size (e.g., diameter, width, shape, etc.) and amount of cable C to be used, and depending on the size of the enclosure 110 and of the cable spool 120.

In illustrative examples, the cable management device 100 is a network interface device (NID). In illustrative examples, the cable management device 100 is configured for storing, for example, fiber optic cable, coaxial cable, twisted pair cabling, or any other cable configured for data or power transmission.

In illustrative examples (see e.g., FIG. 1D), the cable spool 120 can be secured in the closed rotational position by a detent 128, which may be located under the cable spool 120. The detent can be disabled (e.g., via a switch) to unlock the cable spool 120 from the closed rotational position and allow rotation toward the open rotational position. This detent 128 feature can prevent inadvertent rotation of the cable spool 120 and unspooling of the cable C. This feature can thus provide a single unlocking action and may save installation time and provide for easier installation, compared to conventional cable management devices requiring the installer to spread open a clip or open a fastener with every pass of cable.

In the illustrated example, the detent 128 may be a cantilevered tab integral to cable spool 120 that fits into a notch in a rib of the enclosure 110. As the user begins to rotate the cable spool from the closed position toward the open position, the detent 128 contacts the rib in enclosure 110 and is flexed to the side. The slight resistance associated with the opening action helps to retain the cable spool 120 in the closed position except where a deliberate action is applied.

In illustrative examples, a cable management device 100 includes a plurality of first and second retaining features 112, 122 correspondingly defining a plurality of spaces S. The first retaining features 112 can be disposed circumferentially around the cable spool 120, to define a main cable stack storage area 140 at the periphery of the cable spool 120.

In illustrative examples, as an additional cable management feature, an interior portion of the cable spool 120 can include a secondary cable slack storage area 150 including, for example, retaining tabs 152 for holding cable slack.

In illustrative examples, the enclosure 110 can include egress holes (not shown) oriented toward a mounting surface (e.g., a wall), for example on a back surface of the enclosure 110. Those egress holes can be plugged by egress hole plugs 164 for suitable sealing of the enclosure 110 when the egress holes are not in use.

In illustrative examples, as an additional cable management feature, a splice chip 166 can be disposed, for example, at the back surface of the enclosure 110 on the rotatable cable spool 120. In the illustrated form, the enclosure 110 may include fixed tabs and a flexible splice chip 166 that can fit under the fixed tabs. in other forms, the splice chip can be mounted for example using snapping tabs. The splice chip 166 can allow for connection between cables within the enclosure 110.

In illustrative examples, as an additional cable management feature, the enclosure 110 can be fitted with a removable panel 168, for example for fiber connectors. The removable panel 168 can be slid into position on the cable spool 120, and can be snap-fit in place. The ability to remove the panel 168 may aid in initial installation of connectors; the presence of which may be useful in troubleshooting.

In illustrative examples, the enclosure 110 can be mounted, for example, to a wall, by screws through mounting holes 160. Alternatively, any other suitable mounting feature can be implemented.

In illustrative examples, the cable management device 100 includes a cable entry opening 130 fitted with a segmented grommet 132 including a plurality of telescoping tubular segments 133.

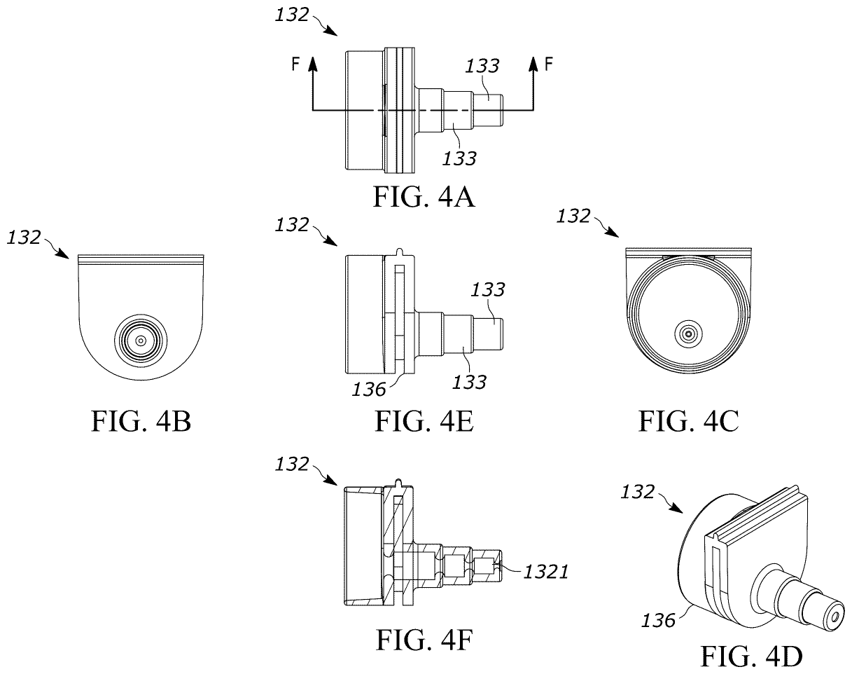

FIG. 4 shows schematic view of an illustrative segmented grommet 132. The tubular segments 133 are differently sized in order to accommodate various cable size (e.g., diameter, width, shape, etc.) ranges. For example, the segmented grommet 132 can be cut by the installer at a tubular segment 133 corresponding to the size of a cable to be passed through a through opening 1321 of the tubular grommet 132, and through the cable entry opening 130. In other examples, the segmented grommet 132 may be modular and the tubular segments 133 may be removably connectable to one another. A user may remove and/or replace tubular segments 133 based on the corresponding size (e.g., diameter, width, shape, etc.) of the cable. The tubular segments 133 may be connected together with a snap fit or friction fit such that there is a substantially watertight interface between adjacent tubular segments 133.

In illustrative examples, the segmented grommet 132 is removable from the cable entry opening 130 to facilitate installation. Accordingly, a convenient installation method can include passing the cable through the segmented grommet 132 prior to the fitting of the cable entry opening 130 with the segmented grommet 132.

In illustrative examples, the segmented grommet is configured to fit into the cable entry opening 130 in two opposite orientations, for example by fitting the slit 136 onto an edge of the cable entry opening 130. For example, the segmented grommet 132 can face inward or outward relative to the enclosure 110. In some instances, the segmented grommet 132 can be secured to the cable using a cable tie 135 (see FIG. 3) to provide strain relief. In other examples, the grommet 132 may be configured to fit into the cable entry opening 130 in only a single orientation.

The segmented grommet 132 can thus provide sealing of the enclosure 110 (e.g., against moisture) at the cable entry opening 130. In illustrative applications, the segmented grommet 132 can provide superior sealing and watertight properties compared to conventional slit-type grommets, and can allow for easier installation and less expensive implementation compared to permanently-attached and expensive liquid-tight cord grips.

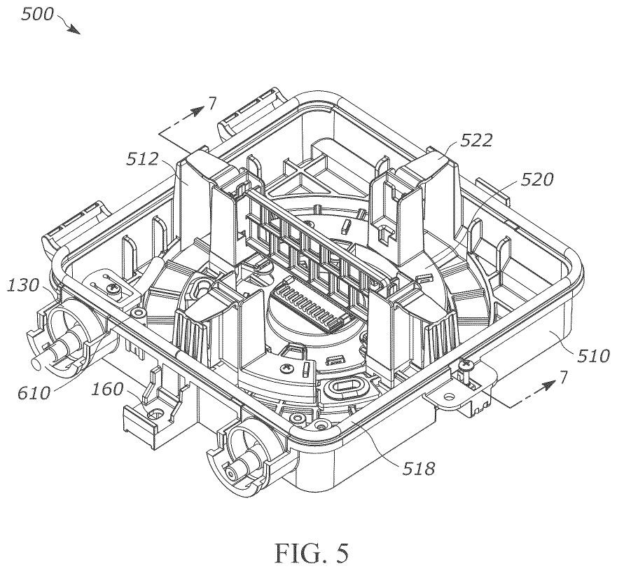

An illustrative operation of the cable management device 100 includes moving the second retaining feature 122 from the closed rotational position to the open rotational position to increase the distance D between the first and second retaining features 112, 122 to open the corresponding space S between the first and second retaining features 112, 122, spooling a cable C around the cable spool 120, and moving the second retaining feature 122 from the open position to the closed position to decrease the distance D between the first and second retaining features 112, 122 to reduce or close the corresponding space S between the first and second retaining features 112, 122. In the illustrated example, moving the second retaining feature 122 is accomplished by rotating the cable spool 120 such that the open and closed positions are open rotational and closed rotational positions. However, the second retaining feature 122 may be moved in other ways (see e.g., FIGS. 5 to 8).

FIGS. 5 to 8 illustrate a cable management device 500, which is similar to the cable management device 100. Some similarities and differences between the cable management devices 100, 500 are described below. Similar elements are labeled with the same reference numbers plus “400”.

The cable management device 500 includes an enclosure 510 and a cable spool 520 mounted to the enclosure 510. The enclosure 510 includes a first retaining feature 512, and the cable spool 520 includes a second retaining feature 522. The cable management device 500 may include a door (not shown) similar to door 114 that can enclose the enclosure 510. A gasket 518, generally coupled to the door, may be shown for illustrative purposes.

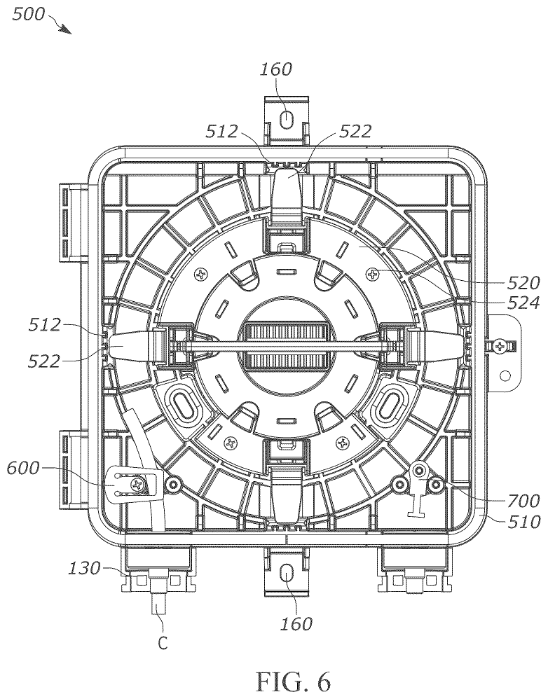

In some forms, the cable spool 520 may be fixed relative to the enclosure 510. For example, fasteners 524 (see e.g., threaded screws in FIG. 6) may secure the cable spool 520 to the enclosure 510. Unlike the cable spool 120 that includes a slotted hole 126, the cable spool 520 includes holes that are substantially the same size as the fasteners 524 to limit relative movement between the cable spool 520 and the enclosure 510.

In some forms, the second retaining feature 522 of the cable spool 520 may be tabs that are movable relative to the remainder of the cable spool 520. For example, the second retaining feature 522 may be a cantilever member with a free end that extends toward the respective first retaining feature 512 of the enclosure 510. The second retaining feature 522 may be movable to increase the distance D between the first and second retaining features 512, 522 to open a corresponding space S between the first and second retaining 512, 522 features.

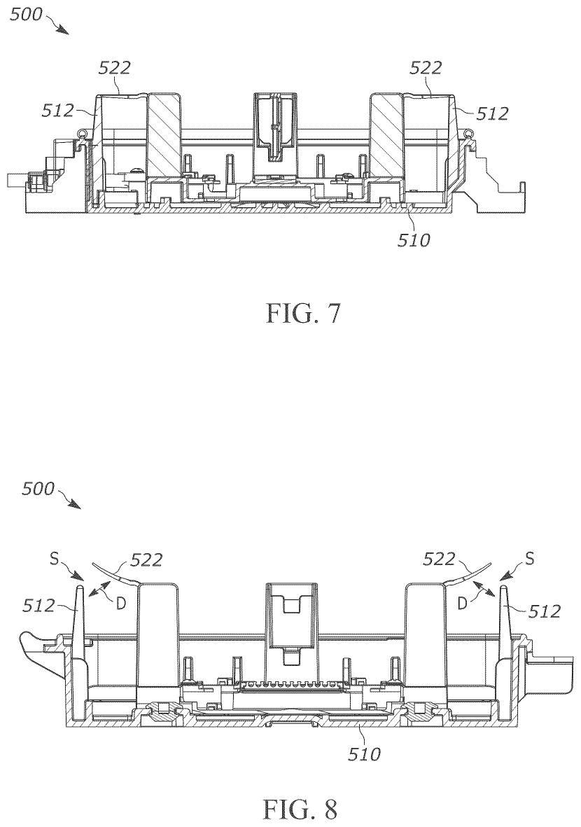

In certain forms, the second retaining feature 522 may be movable between a first position (see e.g., FIG. 7) and a second position (see e.g., FIG. 8). In the first position, the second retaining feature 522 may be in contact with the first retaining feature 512. The second retaining feature 522 may be in a neutral position (e.g., resting on the first retaining feature 512) or may be slightly biased by the first retaining feature 512. In the second position, the free end of the second retaining feature 522 may flex away from the first retaining feature 512. For example, a user may move the second retaining feature 522 toward an upper end of the enclosure 510 to increase the distance D. The second retaining feature 522 may be biased toward the first position so that it returns to the first position after a force is released.

In one form, each of the tabs (e.g., four shown) of the second retaining feature 522 may be movable independently from the other tabs of the second retaining feature 522.

In one form, moving the second retaining feature 522 a distance D to the second position may not cause the second retaining feature 522 to yield. In some forms, this angular movement away from the first retaining feature 512 may be between about 0 degrees and about 90 degrees. In some forms, this angular movement away from the first retaining feature 512 may be between about 1 degree and about 45 degrees. In some forms, this angular movement away from the first retaining feature 512 may be between about 1 degree and about 20 degrees. In some forms, this angular movement away from the first retaining feature 512 may be about 5 degrees.

In one form, the second retaining feature 522 may include hinges (not shown) proximate to fixed end of each tab and may permit the free end to move (e.g., pivot between the first position and the second position). The hinges may be biased toward the first position. In some forms, the hinges may be lockable to retain the tabs of the second retaining feature 522 in the first position.

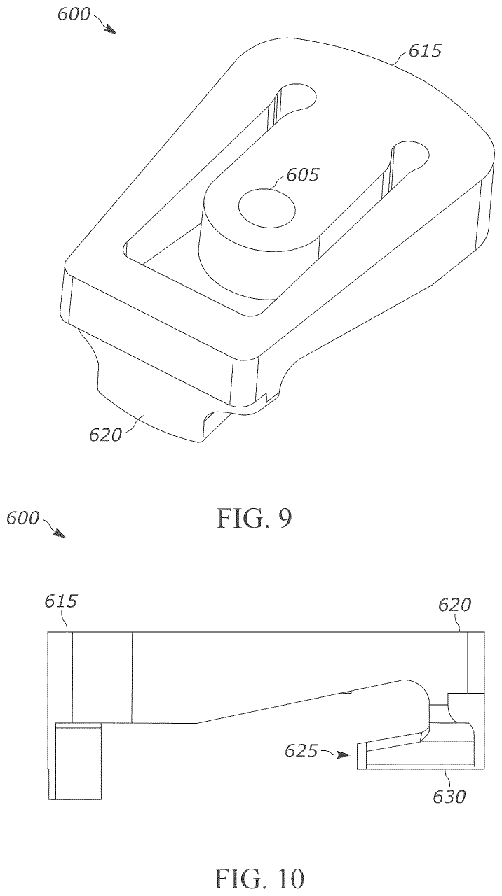

A cable clamp 600 is illustrated in FIGS. 9 to 11. The cable clamp 600 may be connected within the enclosure 510 (or the enclosure 110) to further support a cable C. For example, the cable clamp 600 may include an aperture 605, which may be aligned with a projection (e.g., similar to projection 610) extending from an interior surface of the enclosure 510. A fastener (e.g., a threaded screw) may extend through the aperture 605 and the projection to secure the cable clamp 600 to the enclosure 510.

In some forms, the cable clamp 600 may be pivotable relative to the projection about the fastener. For example, the fastener may be at least partially loosened and the cable clamp 600 may be able to pivot even while the fastener is not completely removed. This may assist in permitting adjustments without fully requiring disassembly.

The cable clamp 600 may include a first end 615 and a second end 620 opposite to the first end 615. The first end 615 may be positioned proximate to an edge of the enclosure 510 and the second end 620 may extend at least partially toward a center of the enclosure 510. In some forms, the second end 620 may include a cantilever portion 625, which may enhance the overall flexibility of the cable clamp 600.

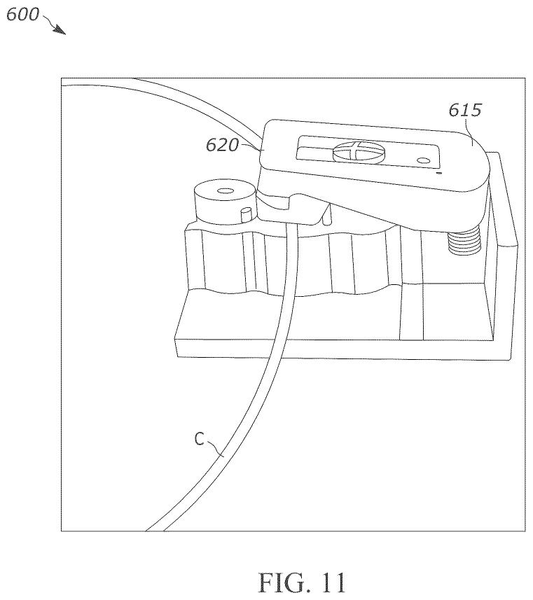

The cable clamp 600 may limit compression of the cable C. As shown in FIG. 11, a bottom surface 630 (see FIG. 10) of the second end 620 of the cable clamp 600 may contact the cable C. The fastener may be tightened until the cable clamp 600 bottoms out. The bottom surface 630 of the cable clamp 600 impinges on the cable C, forcing the cable clamp 600 to flex upward and thereby generating a deterministic amount of compressive force against the cable C which may be generally independent from the fastener. Compression in the cable C is developed as the cable clamp 600 flexes, which may create the controlled compression.

In some forms, the cable clamp 600 may include at least one rib that may interlock with at least one rib of the enclosure 510. The cable clamp 600 may be properly aligned when the ribs are engaged. In other forms, a user may pivot the cable clamp 600 to facilitate entry of the cable C into the enclosure 510. The user may re-tighten the fastener once the cable C is within the enclosure 510 and the cable clamp 600 is aligned with the cable C.

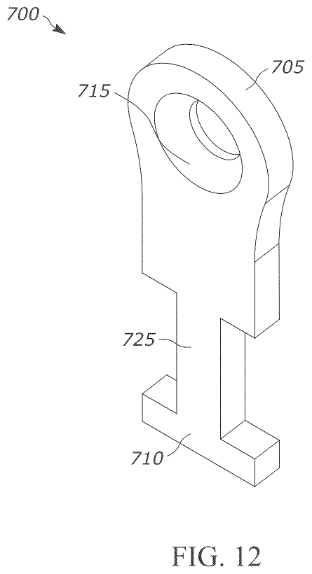

As shown in FIG. 12, other types of cable clamps 700 may be used. The illustrated cable clamp 700 may include a first end 705 and a second end 710 opposite to the first end 705. The first end 705 may include an aperture 715 that may receive a fastener to fasten the cable clamp 700 to the enclosure 510. The second end 710 may include a T-shape 725, which may be used to accommodate a cable tie or a hose clamp (not shown). The cable tie connected to the second end 710 to provide a compressive force on the cable C. The T-shape 725 may limit the cable tie from being inadvertently removed.

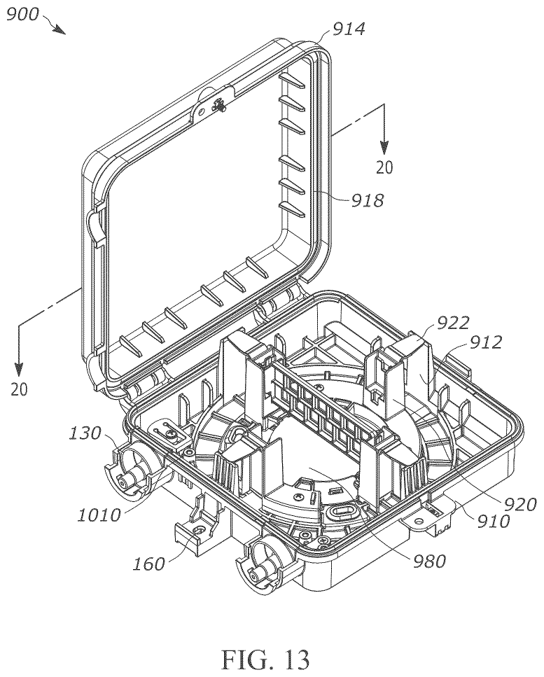

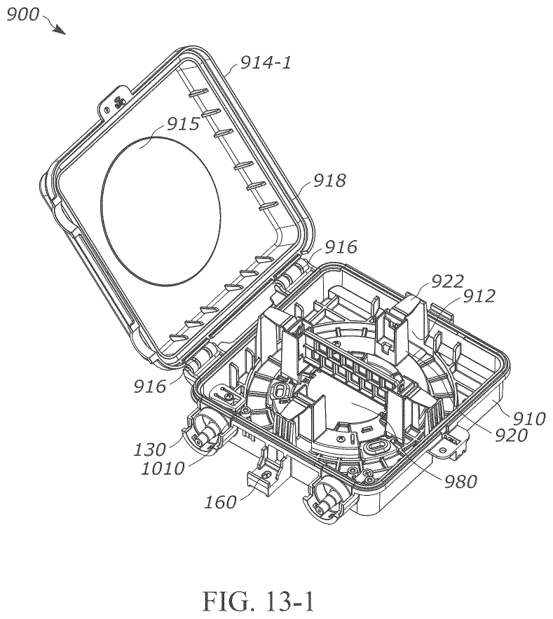

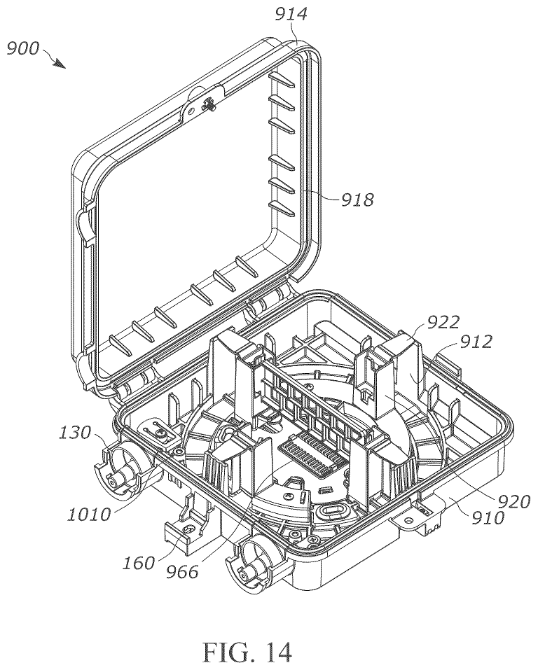

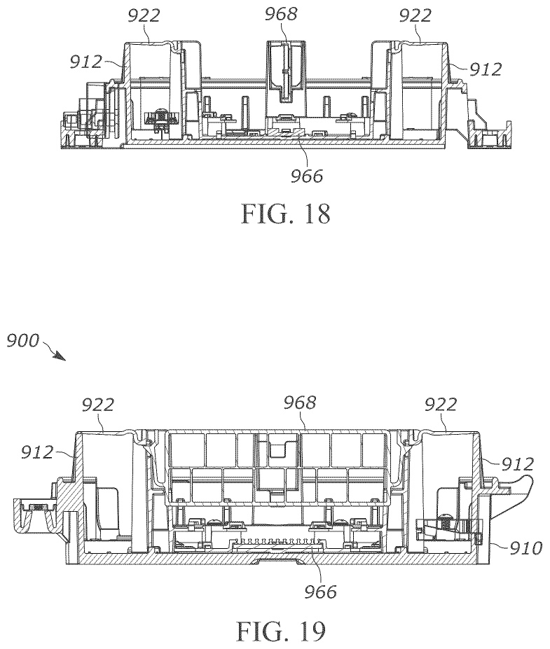

FIGS. 13 to 20 illustrate a cable management device 900, which is similar to the cable management device 100. Some similarities and differences between the cable management devices 100, 900 are described below. Similar elements are labeled with the same reference numbers plus “800”.

The cable management device 900 includes an enclosure 910 and a cable spool 920 mounted to the enclosure 910. The enclosure 910 includes a first retaining feature 912, and the cable spool 920 includes a second retaining feature 922. The cable management device 900 may include a door 914 similar to door 114 that can enclose the enclosure 910. A gasket 918, generally coupled to the door, may be shown for illustrative purposes.

As shown in FIG. 13, some examples of the door 914 may include a substantially flat inner surface. However, other examples of the door 914-1 may include a thickened region 915. As illustrated in FIG. 13-1, a portion of the door 914-1 may have a region 915 with a different thickness than the surrounding regions. For example, the thickened region 915 may be disposed at approximately the center of the door 914-1. Although, other examples may include the thickened region 915 at another region on the door 914-1.

In some forms, the thickened region 915 may be substantially circular in shape. Although other examples may include a region 915 that has a different shape (e.g., elliptical, triangular, rectangular, etc.). The thickened region 915 may assist in improving the drop and impact performance of the enclosure 910 by providing a larger cross section to directly resist external (e.g., drop) forces.

In some forms, the thickened region 915 may be sized so that its outer width is at least equal to the length of the removable panel 968. This may permit the thickened region 915 to pass over at least a portion of the second retaining features 922. The thickened region 915 may also assist in improving the drop and impact performance of the enclosure 910.

As illustrated in FIGS. 14 to 16-1, the door 914 may be pivotably connected to the enclosure 910. For example, the enclosure 910 may include male hinge portions 916 and a female hinge portion 917. The hinge portions 916, 917 may connect together (e.g., with a snap fit) and permit pivoting of the door 914 relative to the enclosure 910.

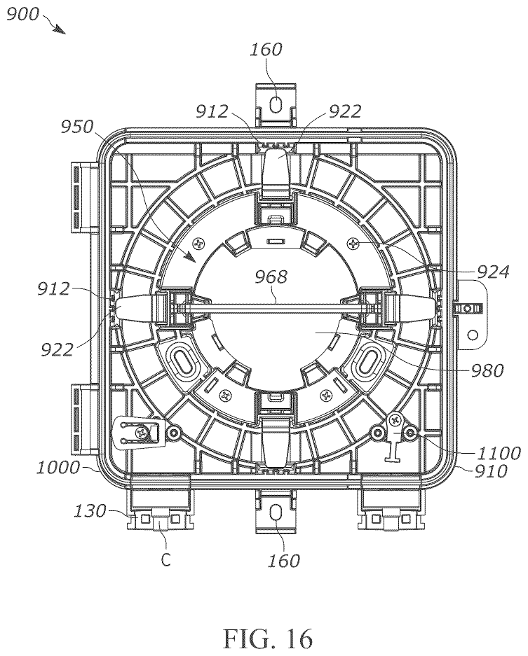

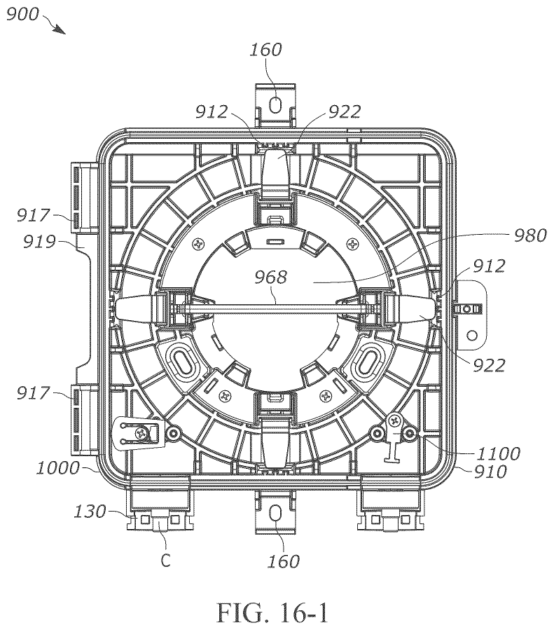

As shown in FIG. 16-1, some examples of the enclosure 910 may include a reinforced region 919. The reinforced region 919 may extend between the hinge portions 917. This may assist in improving the drop and impact performance of the enclosure 910.

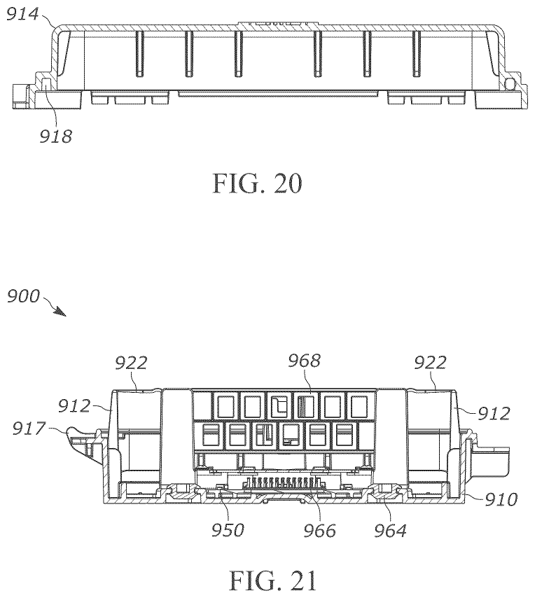

As shown in FIG. 20, the gasket 918 may be a formed with a solid cross section. In other examples, the cross section of the gasket 918 (or any other gasket) may have a hollow or partially hollow cross section.

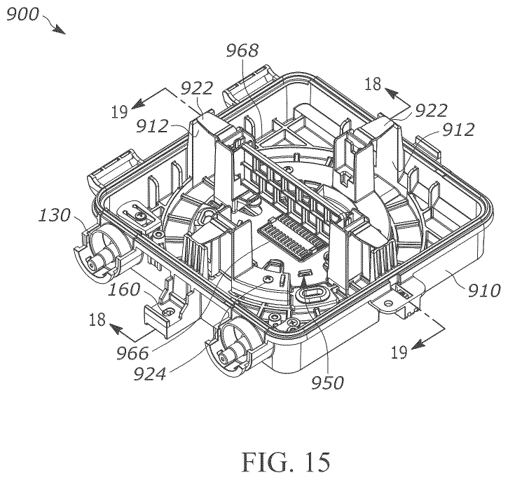

In some forms, the cable spool 920 may be fixed relative to the enclosure 910. For example, fasteners 924 (see e.g., threaded screws in FIG. 15) may secure the cable spool 920 to the enclosure 910. Like the holes in the cable spool 520, the cable spool 920 may include holes that are substantially the same size as the fasteners 924 to limit relative movement between the cable spool 920 and the enclosure 910.

In some forms, the second retaining feature 922 of the cable spool 920 may be tabs that are movable relative to the remainder of the cable spool 920. For example, the second retaining feature 922 may be a cantilever member with a free end that extends toward the respective first retaining feature 912 of the enclosure 910. The second retaining feature 922 may be movable to increase the distance D between the first and second retaining features 912, 922 to open a corresponding space S between the first and second retaining features 912, 922 (see e.g., the example illustrated in FIG. 8).

Similar to the second retaining feature 522, the retaining feature 922 may be movable between a first position (see e.g., FIG. 15) and a second position (not shown but similar to FIG. 8). The second retaining feature 922 may be in a neutral position and in contact with (or close proximity with) the first retaining feature 912, and the free end of the second retaining feature 922 may be flexed away from the first retaining feature in the second position.

In one form, each of the tabs (e.g., four shown) of the second retaining feature 922 may be movable independently from the other tabs of the second retaining feature 922.

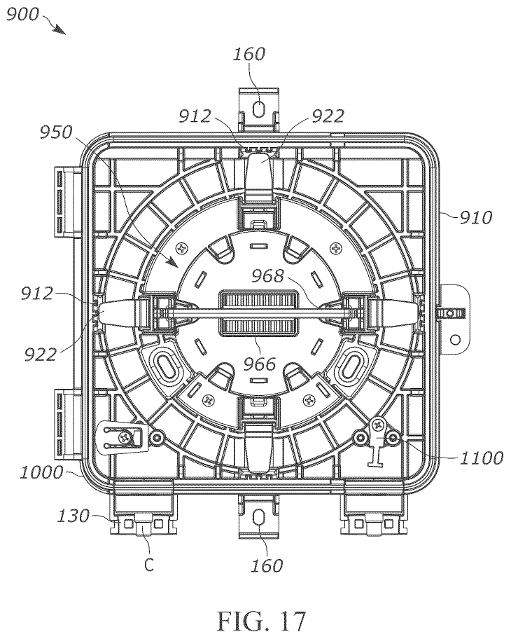

As shown in FIGS. 17 to 19, the splice chip 966 may be recessed compared to the position of the splice chip 566 in FIG. 8. For example, the splice chip 966 may be disposed on a lower surface of storage area 950. A mounting surface for the splice chip 966 may be a substantially circular shape as compared to an annular shape for the cable management device 500 (see e.g., FIG. 5). In other words, the region of the storage area 950 may be substantially flat compared to the similar region in the enclosure 510, where the splice chip is mounted to a raised area.

In some forms, the surface onto which the egress hole plugs 964 are mounted may be substantially flush with the storage area 950. In other words, these two surfaces may be substantially co-planar with one another.

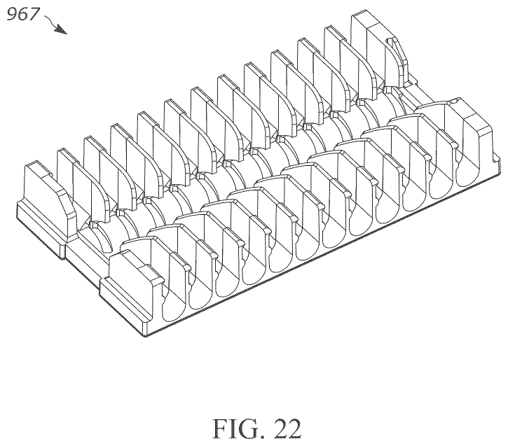

The illustrated splice chip 966 includes twelve rows. However, other examples may include a different number of rows to include a different number of splices. For example, FIG. 22 may include a splice chip 967 that may include a greater number of rows so that it can accommodate a greater number of splices (e.g., twenty-four splices). For example, the splice chip 967 may include two rows, each having twelve slots to receive the twenty-four splices. In other examples (not shown), there may be a smaller number of rows.

As shown in FIGS. 13 and 16, a cover 980 may be positioned at least partially over the splice chip 966. In some forms, the cover 980 may be constructed from a flexible material (e.g., a flexible plastic film). In other forms, the cover 980 may be formed from a rigid material (e.g., a rigid plastic material).

The cover 980 may be removably fixed above the splice chip 966. In some forms, the cover 980 may be transparent or translucent, and may permit a user to view the splice chip 966 while the cover 980 is connected. In other examples, the cover 980 may be opaque and the splice chip 966 may not be visible.

In some forms, the cover 980 may be secured in position using a snap-fit, a press-fit, or a friction-fit. In other examples, a fastener (e.g., a screw) may be used to secure the cover 980. In still other examples, a magnet may be used to secure the cover 980. In still other examples, multiple methods may be used to secure the cover 980.

One of ordinary skill will appreciate that the exact dimensions and materials are not critical to the disclosure and all suitable variations should be deemed to be within the scope of the disclosure if deemed suitable for carrying out the objects of the disclosure. In this regard, the cable management device and its constituent parts can be of any size, without departing from the scope of the present disclosure.

One of ordinary skill in the art will also readily appreciate that it is well within the ability of the ordinarily skilled artisan to modify one or more of the constituent parts for carrying out the various examples of the disclosure. Once armed with the present specification, routine experimentation is all that is needed to determine adjustments and modifications that will carry out the present disclosure.

The above examples are for illustrative purposes and are not intended to limit the scope of the disclosure or the adaptation of the features described herein to particular cable management devices. Those skilled in the art will also appreciate that various adaptations and modifications of the above-described preferred examples can be configured without departing from the scope and spirit of the disclosure. Therefore, it is to be understood that, within the scope of the appended claims, the disclosure may be practiced other than as specifically described.

1. A cable management device comprising:
an enclosure including a first retaining feature; and
a cable spool mounted to the enclosure, and including a second retaining feature,
wherein the second retaining feature is movable between a closed position and an open position, such that moving the second retaining feature from the closed position to the open position increases a distance between the first and second retaining features to open a corresponding space between the first and second retaining features.

2. The cable management device claimed in claim 1, comprising a plurality of corresponding first and second retaining features respectively defining a corresponding one of a plurality of spaces, the plurality of first retaining features being disposed circumferentially around the cable spool,
wherein the plurality of first retaining features includes the first retaining feature, the plurality of second retaining features includes the second retaining feature, and the plurality of spaces includes the space.

3. The cable management device claimed in claim 1, wherein the cable spool is rotatably mounted to the enclosure by at least one fastener disposed through a slotted hole of the enclosure or of the cable spool, wherein the at least one slotted hole defines an angular difference between the closed and open rotational positions of the cable spool, and wherein the second retaining feature is configured to move with the rotation of the cable spool.

4. The cable management device claimed in claim 1, further comprising a secondary cable slack storage area defined by retaining tabs in the cable spool.

5. The cable management device claimed in claim 1, wherein the enclosure includes a cable entry opening fitted with a segmented grommet, the segmented grommet including a plurality of telescoping tubular segments having different sizes.

6. The cable management device claimed in claim 5, wherein the segmented grommet is configured to fit into the cable entry opening in two opposite orientations.

7. The cable management device claimed in claim 1, wherein the cable spool is rotationally fixed relative to the enclosure and the second retaining feature is configured to flex between the open position and the closed position.

8. The cable management device claimed in claim 1, wherein the second retaining feature is formed as a cantilever member and is configured to flex between the closed position and the open position, and wherein the second retaining feature is biased toward the closed position.

9. The cable management device claimed in claim 1, further comprising a cable clamp secured to the enclosure with a fastener, wherein the cable clamp includes a cantilever portion having a bottom surface configured to contact a cable, and wherein a force configured to be applied by the cable clamp is independent of the torque applied by the fastener when the fastener is tightened to limit of its travel.

10. A method for storing cable in a cable management device, the cable management device comprising an enclosure including a first retaining feature, and a cable spool mounted to the enclosure and including a second retaining feature, the second retaining feature movable between a closed position and an open position, wherein the method comprises:
moving the second retaining feature from the closed position to the open position to increase a distance between the first and second retaining features to open a corresponding space between the first and second retaining features;
spooling a cable around the cable spool; and
moving the second retaining feature from the open position to the closed position to decrease the distance between the first and second retaining features to reduce or close the corresponding space between the first and second retaining features.

11. The method claimed in claim 10, wherein the cable management device comprises a plurality of corresponding first and second retaining features respectively defining a corresponding one of a plurality of spaces, the plurality of first retaining features being disposed circumferentially around the cable spool, wherein the plurality of first retaining features includes the first retaining feature, the plurality of second retaining features includes the second retaining feature, and the plurality of spaces includes the space.

12. The method claimed in claim 10, wherein the cable spool is rotatably mounted to the enclosure by at least one fastener extending through a slotted hole of the enclosure or of the cable spool, wherein the at least one slotted hole defines an angular difference between the closed and open rotational positions of the cable spool, and wherein the second retaining feature is configured to move with the rotation of the cable spool.

13. The method claimed in claim 10, wherein the enclosure includes a cable entry opening, and wherein the method further comprises:
fitting the cable entry opening with a segmented grommet, the segmented grommet including a plurality of telescoping tubular segments having different sizes.

14. The method claimed in claim 13, further comprising:
cutting the segmented grommet at a tubular segment corresponding to a size of the cable.

15. The method claimed in claim 13, further comprising:
passing the cable through the segmented grommet prior to the fitting of the cable entry opening with the segmented grommet.

16. The method claimed in claim 10, wherein the second retaining feature includes a plurality of tabs, and wherein each tab biased toward the closed position and is automatically moved from the open position to the closed position when a force is released.

17. The method claimed in claim 10, wherein the cable spool is rotationally fixed relative to the enclosure and the second retaining feature is configured to flex between the open position and the closed position.

18. The method claimed in claim 10, wherein the second retaining feature is formed as a cantilever member and is configured to flex between the closed position and the open position, and wherein the second retaining feature is biased toward the closed position.

19. The method claimed in claim 10, further comprising securing a cable clamp to the enclosure by tightening a fastener and positioning a cable in contact with a bottom surface of a cantilever portion, and wherein the force from the cable clamp is independent of the torque applied to the fastener when the fastener is tightened to limit of its travel.

20. The method claimed in claim 19, further comprising loosening the fastener and pivoting the cable clamp relative to the enclosure and re-tightening the fastener, wherein pivoting the cable clamp is configured to permit entry of the cable into the enclosure.

21.-31. (canceled)
